(19) United States
(12) Patent Application Publication
(10) Pub. No.: US 2006/0246862 A1
(43) Pub. Date: Nov. 2, 2006

(54) Local oscillator for a direct conversion transceiver

(76) Inventors: Bipul Agarwal, Irvine, CA (US); John E. Vasa, Irvine, CA (US); David Leslie Yates, San Clemente, CA (US); Chang-hyeon Lee, Irvine, CA (US); Aravind Loke, Irvine, CA (US)

Correspondence Address: WILLIAM J. KOLEGRAFF, 3119 TURNBERRY WAY, JAMUL, CA, 91935, US

(21) Appl. No.: 11/116,087

(22) Filed: Apr. 27, 2005

(51) Int. Cl. H04B 7/00

(52) U.S. Cl. 455/260

(57) ABSTRACT

A local oscillator circuit for generating a local frequency signal is provided. The local oscillator circuit may cooperate with a radio circuit for providing wireless reception or transmission. The radio circuit performs modulation or demodulation processes with reference to a defined carrier signal frequency. The local oscillator circuit has a voltage controlled oscillator that generates a VCO signal at frequency different than the carrier frequency. A frequency scaling circuit applies a scaling factor to the VCO signal, with the scaled signal generated at the frequency of the defined carrier frequency.

### BACKGROUND

The field of the present invention is electronic circuits for generating a frequency signal. More particularly, the invention relates to an electronic circuit and process for generating a local oscillator signal for a radio.

Wireless communication systems generally transmit a modulated radio frequency (RF) signal that is converted to a baseband signal in a receiver. A conventional receiver does this conversion in a two-stage process. In a first stage, the RF signal is down converted to an intermediate frequency (IF) signal, and then in a second stage, the IF signal is further down converted to the baseband frequency. In a similar manner, a conventional radio transmitter generates the modulated radio frequency (RF) signal in a two-stage process. In a first stage, the baseband signal is up converted to an intermediate frequency (IF), and then in a second stage, the IF signal is further up converted on to the carrier signal. This two stage process enables simplified filtering and processing, but the two-stage architecture consumes valuable space and power in wireless devices. Accordingly, a newer single-stage architecture is being deployed. This single-stage architecture converts directly between the RF signal directly and the baseband signal, and is typically, referred to as a direct conversion radio. The direct conversions process may be applied to the receiver section, the transmitter section, or both the receiver and the transmitter.

As an alternative, some of the benefits of the direct conversion structure may be realized using a low IF architecture, while retaining some of the simplified filtering and processing of the IF structure. A low IF radio uses an intermediate frequency that is much lower than the IF of a conventional radio. In this way, some of the difficulties of implementing the direct conversion radio are avoided, but the low IF also does not enable the full benefit of direct conversion. To simplify discussion, it will be understood that direct conversion also includes such low-IF systems.

In operation, a direct or low IF radio uses a voltage controlled oscillator to generate a signal operating at the desired carrier frequency. For example, if a radio is operating on a CDMA standard, then a carrier frequency of 824 MHz may be needed. In such a case, the voltage controlled oscillator is set to output a 824 MHz signal to the radio circuit. The radio circuit receives the 824 MHz signal, and uses it as the reference carrier signal. There are numerous telecommunications standards, with each standard defining specific transmitter and receiver carrier frequencies. If the radio is operating as a transmitter, then a baseband signal is modulated on to the carrier signal, and the modulated signal is transmitted via an antenna. If the radio is operating as a receiver, then the carrier signal is removed, and the demodulated baseband signal processed in the baseband circuit of the radio.

When implementing a low IF or direct conversion transmitter, a voltage controlled oscillator generates a local oscillator signal. Typically, the local oscillator signal operates between about 400 MHz and 2.2 GHz, depending on the particular telecommunications standard being used. This local oscillator signal is then used as the carrier frequency for the radio. A baseband portion of the radio provides a baseband signal, which operates at a much lower frequency than the carrier signal, generally in the range of a few hundred kilohertz. This baseband signal is then modulated on to the carrier signal. Since the carrier frequency is so much faster than the baseband signal, the frequency of the modulated signal is very close to the frequency of the frequency of the carrier signal itself. The modulated signal is amplified and transmitted from the radio via an antenna or other radiating device.

However, the transmitted signal is radiated at a relatively high power, and, as discussed above, is operating at a frequency close to the frequency of the carrier signal in the radio circuitry. Even though the radio may be well shielded, it is likely that the transmitted signal still couples to and interferes with the radio circuitry. For example, the transmitted signal may affect the voltage controlled oscillator (VCO). If the transmitted signal couples back to the VCO, then the VCO may become unstable, resulting in frequency shifts and phase noise. These effects, commonly referred to as “VCO pulling” cause an undesirable frequency jitter and a distortion in the output signal. The effects of VCO pulling may be reduced by positioning the VCO farther from the antenna, or by increasing the amount of shielding around the VCO. Unfortunately, as wireless devices become smaller, and radios are offered as single-chip devices, it becomes more difficult to adequately decouple the VCO from the transmitted signal.

The VCO pulling problem results from the transmitted signal coupling back to the VCO circuit. In a similar manner, another problem exists when the VCO signal couples to the radio circuit. This problem, often referred to as “carrier feedthrough” exists when the VCO signal couples to the transmitter circuitry. In such a case, the stray VCO signal is amplified and transmitted from the wireless device. Accordingly, even when no baseband signal is being transmitted, the wireless device is still transmitting the VCO signal, which wastes device power and may substantially reduce capacity in some telecommunication architectures such as CDMA. For these reasons, some telecommunications standards have strict limits on the level of allowable carrier feedthrough.

Just as with the direct conversion transmitter, the direct conversion receiver also suffers from implementation difficulties. When implementing a low IF or a direct conversion receiver, there is typically some amount of offset (referred to as “DC offset”) that appears on the downconverted baseband signal. The DC offset may occur due to due to self-mixing that can occur between the local oscillator (LO) signal from the VCO and the received radio frequency (RF) signal. Correction for DC offset is typically performed on the baseband amplifier located in the receiver. Many techniques have been proposed to minimize DC-offset. For example, it is possible to minimize DC offset using digital calibration techniques in the analog-to-digital converter (A/D) located in the receiver. Alternately, sampling techniques and Sample-and-Hold (S/H) circuits have been used to subtract the estimated offset of the variable gain amplifier from the received signal.

Unfortunately, one or all of these techniques can only be applied to a system in which the receiver does not continuously operate, such as in a TDMA communication system, and even then add an undesirable level of complexity. In a CDMA system, these techniques will not be effective because the receiver works continuously with no interruption. Furthermore, DC-offset correction using so called “auto-zeroing” techniques during start-up is not practical in a CDMA system because of dynamic offsets. In a CDMA system the only option that shows promise is the implementation of a so called “servo-loop” like architecture around the variable gain amplifier.

In a servo-loop architecture, the high pass cut-off frequency is dependent upon the gain characteristics of the variable gain amplifier and the amplifiers in the servo-loop. Because the transconductance of the variable gain amplifier varies significantly with the applied gain control signal (usually above 50 dB of range), the cut-off frequency varies by more than 50 dB, which places the cut-off frequency at a point at which data carried in the received signal will likely be lost. It is possible to adjust the high pass cut-off frequency by varying the gain of the amplifiers in the servo-loop inversely proportional to the transconductance amplification of the VGA. Since the transconductance amplification of the VGA varies proportionally to the exponential of the control voltage, the amplification of the amplifiers in the servo-loop must vary with the inverse of the exponential of the control voltage. Unfortunately, such a servo-loop increases significantly the complexity, power consumption and the area on the device occupied by the architecture.

Therefore, it would be desirable to reduce the effects VCO pulling and carrier feedthrough in a direct conversion transmitter. Further, it would be desirable to reduce the effects of DC offset in a direct conversion receiver.

### SUMMARY

Briefly, the present invention provides a local oscillator circuit for generating a local frequency signal. The local oscillator circuit may cooperate with a radio circuit for providing wireless reception or transmission. The radio circuit performs modulation or demodulation processes with reference to a defined or determined carrier signal frequency. The local oscillator circuit has a voltage controlled oscillator that generates a VCO signal at frequency different than the carrier frequency. A frequency scaling circuit applies a scaling factor to the VCO signal, with the scaled signal generated at the frequency of the defined carrier frequency.

Advantageously, the local oscillator circuit operates the VCO at a frequency different from the carrier frequency. By operating at different frequencies, the local oscillator circuit substantially reduces VCO pulling or carrier feedthrough effects when the radio is operating as a transmitter, and reduces the effects of LO mixing and DC offset when the radio is operating as a receiver.

### BRIEF DESCRIPTION OF THE DRAWINGS

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views. It will also be understood that certain components and details may not appear in the figures to assist in more clearly describing the invention.

FIG. 1 is a block diagram of a direct conversion radio in accordance with the present invention;

FIG. 2 is a block diagram of a direct conversion transmitter in accordance with the present invention;

FIG. 3 is a block diagram of a local oscillator circuit in accordance with the present invention;

FIG. 4 is a is flow diagram of a method of providing a carrier frequency in accordance with the present invention;

FIG. 5 is a block diagram of a local oscillator circuit in accordance with the present invention; and

FIG. 6 is a block diagram of a direct conversion receiver in accordance with the present invention.

### DETAILED DESCRIPTION

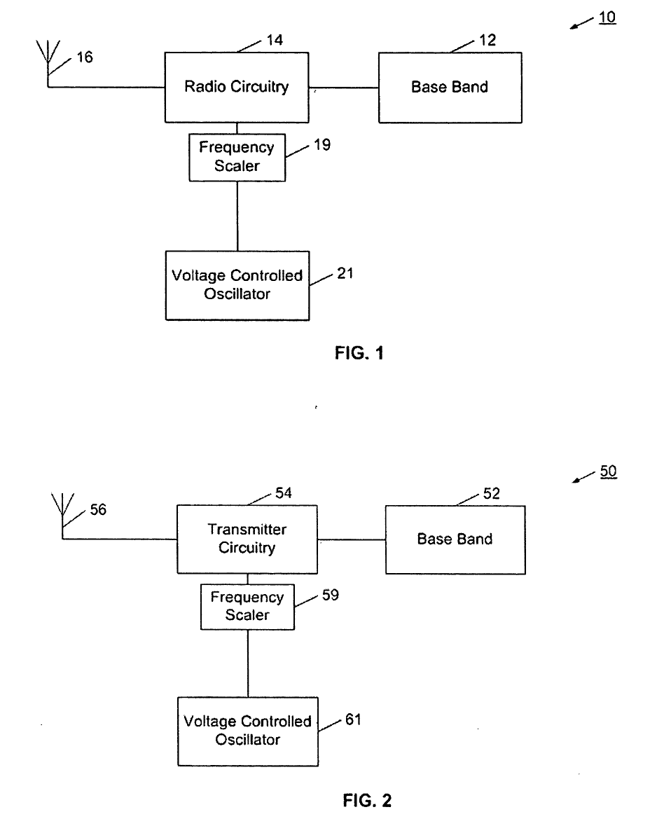

Referring now to FIG. 1, a direct conversion radio 10 is illustrated. The direct conversion radio 10 may be constructed to comply with a wireless standard, such as CDMA, WCDMA, UMTS, CDMA 2000, GSM, or other wireless standard. It will be appreciated that other wireless standards exist, and that existing standards may be revised and modified over time. Also, the general construction of a direct conversion radio is well-known, so will not be discussed in detail herein.

The direct conversion radio 10 comprises baseband circuitry 12 for operating on an informational signal. This informational signal may be, for example, a voice signal, a video signal, a text signal, or other informational or data signal. The baseband circuitry 12 couples to radio frequency circuit 14. The radio circuitry 14 may include transmitter circuitry, receive circuitry, or both. In one example, the radio circuitry 14 is included as part of a wireless mobile device. In this way, the radio circuitry 14 includes both transmitter circuitry and receiver circuitry. The radio circuitry 14 couples to an RF (radio frequency) radiator in the form of antenna 16. The antenna 16 is used to receive or transmit modulated radio frequency signals. These modulated signals have a baseband informational signal modulated onto an RF carrier. The frequency of the RF carrier and the frequency content of the baseband signal are generally defined in the relevant communication standard. For example, a direct conversion radio compliant with a CDMA standard may have a carrier signal in the range of 824 MHz to 849 MHz, while the baseband signal may be provided at around 600 KHz. In another example, a wideband CDMA signal may transmit at 1920-1980 MHz, and receive at 2110-2170 MHz. It will be understood that other frequency ranges are used in compliance with other telecommunication standards.

The direct conversion radio 10 has a frequency source, generally in the form of a voltage controlled oscillator 21, for providing a stable and accurate frequency signal. The voltage controlled oscillator 21 provides its frequency signal at a frequency different than the carrier frequency required under the relevant communication standard. The signal generated by the voltage controlled oscillator 21 is received into frequency scaler 19. The frequency scaler 19 has scaling circuitry for scaling the frequency of the received signal to the desired carrier frequency. For example, if the direct conversion radio 10 requires a carrier frequency of 1850 MHz, the VCO 21 may generate a signal having a frequency of 1233 MHz. The frequency scaler 19 may then apply a scaling factor of 3/2. In this way, the 1233 MHz signal is first multiplied by 3 and then divided by 2 to generate a signal at 1849.5 MHz. It will be appreciated that other VCO frequencies may be used, provided the scaling factor is adjusted accordingly.

The frequency scaler 19 is a relatively simple circuit, generally comprising multiplication and division circuitry, and may be readily incorporated into the radio circuitry 14. In this way, fewer components and traces are operating at or near the carrier frequency, thereby reducing VCO pulling and carrier feed-through effects. Advantageously, the voltage controlled oscillator 21 is operating at a frequency different than the desired carrier frequency. In this way, the amplified and transmitted modulated signal may be readily restricted from distorting or otherwise affecting the voltage controlled oscillator 21. In a similar manner, stray VCO signals that are received by the radio circuitry 14 may be more easily filtered or removed as these stray signals have a frequency different than the carrier frequency.

Referring now to FIG. 2, a direct conversion transmitter 50 is illustrated. The direct conversion transmitter 50 has baseband circuitry 52 that converts an informational signal to a baseband signal. The information signal may be, for example, a voice signal, a video signal, a text signal, or an audio signal. The baseband signal is received into transmitter circuitry 54, where the baseband signal is modulated onto an RF carrier signal. The modulated RF signal is then transmitted using antenna 56. The RF carrier signal is derived from a frequency signal generated by the voltage controlled oscillator 61. The voltage controlled oscillator 61 provides a stable and accurate frequency signal at a frequency different than the desired RF carrier frequency. The signal from the voltage controlled oscillator is received into a frequency scaler 59, where the frequency of the signal is scaled to the desired carrier frequency. In one example, the frequency scaler implements a scaling factor of 3/2. In this way, the carrier frequency is generated by multiplying the VCO signal by 3, and dividing the resulting signal by 2. Since the RF carrier operates at a frequency that is 3/2 different than the VCO signal, the VCO may be operated without significant interference or pulling due to the transmitted signal. In a similar manner, any VCO signal that leaks through to the transmitter circuit is readily filtered, reducing any effects from carrier feedthrough. It will be appreciated that other VCO frequencies and scaling factors may be used.

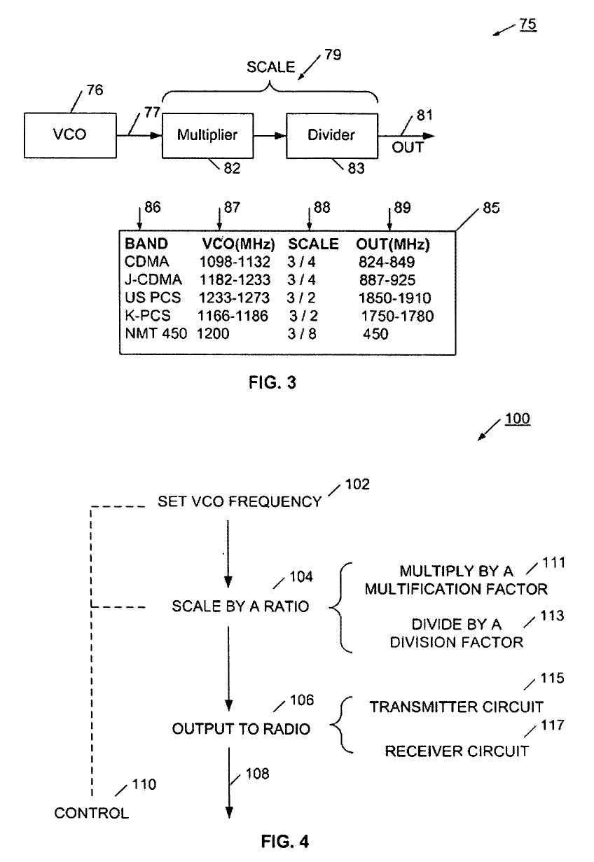

Referring now to FIG. 3 a local oscillator circuit 75 is illustrated. The local oscillator circuit 75 may be advantageously used in association with a wireless radio system. For example, the local oscillator circuit 75 may provide a local oscillator signal for modulating or demodulating in an associated radio circuit. The local oscillator circuit 75 includes a voltage controlled oscillator 76. The voltage controlled oscillator 76 provides a stable and accurate frequency signal to an input line 77. The design and construction of a voltage controlled oscillator is well known so will not be discussed in detail. The output from the voltage controlled oscillator 76 is received into a frequency scaling circuit 79. The frequency scaling circuit applies a scaling factor to the signal received from the voltage controlled oscillator 76.

The scaling factor is selected such that the frequency of the voltage controlled oscillator signal multiplied by the scaling factor equals the frequency of the desired carrier frequency. The scaling factor is selected so that the frequency of the voltage controlled oscillator is sufficiently different from the carrier frequency so that VCO pulling and carrier feed through effects may be substantially reduced through filtering or other processes. Also, the scaling factor is selected to avoid significant harmonics near the carrier frequency. However, the scaling factor should also be selected such that the signal from the VCO has sufficient resolution and accuracy as required by the relevant communication standard. In one example, the scaling factor is set to 3/2. A 3/2 scaling factor has a sufficient frequency difference between the VCO signal and the carrier frequency such that the effects of VCO pulling and carrier feed through may be easily reduced. Also, no substantial harmonics are produced near the frequency of the carrier. Further, the VCO signal is generated at a frequency that provides sufficient resolution and accuracy to support most communication standards. For example, a CDMA system may require a carrier in the range of 1850 to 1910 MHz. Using a 3/2 scaling factor, the VCO would operate from 1233 to 1273 MHz. Since the VCO is still operating in excess of 1.2 GHz, it provides a stable and accurate frequency signal with sufficient resolution to support the required carrier signals and channel separations.

In one example, the frequency scaling circuit 79 is implemented as a multiplier 82 placed in series with a divider 83. Such multiplier 82 and divider 83 circuits may be efficiently and easily constructed. In the example of applying a 3/2 scaling factor, the frequency of the VCO signal at input 77 is first multiplied by 3 by multiplier 82, and then divided 2 by divider 83. The signal is then output on output line 81 for use as a carrier signal. It will be appreciated that the division may be performed before the multiplication, and that other scaling algorithms may be used.

Table 85 illustrates five common telecommunication standards in current use. For each standard, the common name of the band 86 is shown, with the frequency range 89 defined for the carrier frequency. For each band, a possible VCO frequency 87 is identified, along with an associated scaling factor 88. The scaling factor 88 is applied to the VCO frequency 87 to generate an output carrier signal 89 in the identified ranges. For example, the US PCS band requires an output carrier signal 89 in the range from 1850 to 1910 MHz. If a scaling factor 88 is selected to be 3/2, then the VCO 87 is set in the range of 1233 to 1273 MHz. Other bands, such as cellular CDMA, J-CMDA, K-PCS, and NMT450 are also illustrated. It will be appreciated that other bands may be used, and that other scaling factors and VCO frequencies may be substituted.

Referring now to FIG. 4, a method of providing a carrier frequency is illustrated. Method 100 has a frequency signal provided by a VCO as shown in block 102. The VCO frequency is scaled by a scaling ratio as shown in block 104, with the output sent to the radio as illustrated in block 106. The output signal 108 may be provided as a carrier signal to a transmitter 115 or receiver 117 operation within the radio. The VCO frequency and the scaling ratios may be set by a control system 110. The control system 110 may be part of the radio system 106 and in one example may be included on a single integrated circuit with the radio system. The scaling ratio 104 may be implemented by a multiplication 111 and a division 113. It will be appreciated that other scaling algorithms may be used.

In determining the scaling ratio 104, three factors are generally considered. First, the scaling factor should provide a sufficient difference in frequency between the VCO frequency and the carrier frequency such that the effects from VCO pulling and carrier feedthrough may be readily reduced. Second, the scaling factor should be selected so that substantial harmonics of the VCO frequency are not generated near the carrier frequency. And third, the scaling factor should be selected so that the VCO frequency has sufficient resolution and accuracy to support the relevant communication standard. Also, scaling factors closer to 1 require less power to implement. For example, a scaling factor of 3 requires more power to implement than a scaling factor of 3/2, and in a similar manner, a scaling factor of 0.3 requires more power to implement than a scaling factor of 3/4. Therefore, in a wireless environment, such as a mobile wireless environment, where power considerations are important, scaling factors should be selected as close to 1 as appropriate in light of the factors identified above. In one specific example, a scaling factor of 3/2 has been found effective for the US PCS CDMA band. The selection of 3/2 enables sufficient difference in frequency to allow undesirable effects to be easily removed, avoids substantial harmonics at the carrier frequency, provides sufficient resolution to provide required carrier and channel frequencies, and may be implemented using relatively low powered circuitry. It will be appreciated, however, that other application requirements may dictate or allow the use of other scaling factors.

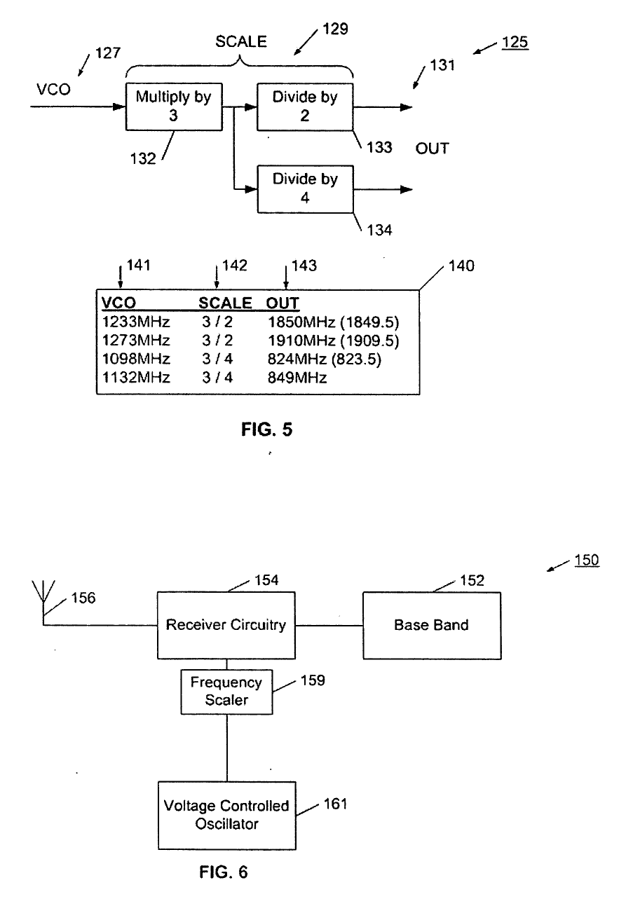

Referring now to FIG. 5, a local oscillator circuit for a CDMA system is illustrated. The local oscillator circuit 125 is intended to create a carrier frequency according to present CDMA telecommunications standards. It will be appreciated that future versions of the CMDA standard may require other carrier frequency ranges, and that other VCO frequencies and scaling factors may be applied to achieve those new frequencies. Local oscillator circuit 127 has a voltage controlled oscillator generating a frequency onto an input line 127. The input frequency is received into a frequency scaling circuit 129. The frequency scaling circuit applies a scaling factor to generate a carrier frequency on output line 131. As illustrated in table 140, the scaling factor 142 may be selected to generate carriers in different CDMA bands. A first scaling factor 142 of 3/2 is implemented by first multiplying by three 132 and then dividing by two 133. In this way, when the VCO frequency 141 is set at 1233 MHz, the output frequency 143 is 1849.5 MHz for implementing the carrier frequency at 1850 MHz. In a similar manner, when the VCO frequency 141 is set to 1273 MHz, the output carrier frequency is at 1909.5 MHz, which implements the 1910 MHz carrier frequency. The 3/2 scaling factor thereby enables the VCO to generate carrier frequencies in the range of 1850 MHz to 1910 MHz to implement a first CDMA band.

To implement a second CDMA band, which extends from 824 MHz to 849 MHz, the scaling factor 142 is selectively set to 3/4. Accordingly, the VCO signal is first multiplied by three 132 and then divided by four 134. When the VCO frequency 141 is set to 1098 MHz then the carrier frequency is output at 823.5 MHz, which implements the 824 MHz carrier frequency requirement. In a similar manner, when the VCO frequency 141 is set to 1132 MHz, then the frequency carrier output 143 is at 849 MHz. A controller (not shown) may be used to select between a scaling factor of 3/2 and 3/4. This enables a single local oscillator circuit 125 to implement a dual band CDMA radio circuit.

Referring now to FIG. 6, a direct conversion receiver 150 is illustrated. The direct conversion receiver 150 has an antenna 156 for receiving a modulated RF signal. The modulated RF signal is received into receiver circuitry 154, where a baseband signal is demodulated from a carrier signal. The baseband signal is received into baseband circuitry 152, where the signal is further processed for use by the wireless device. In the demodulation process, the receiver circuitry 154 uses a locally generated signal at the same frequency as the carrier signal. This local signal is derived from a frequency signal generated by the voltage controlled oscillator 161. The voltage controlled oscillator 161 provides a stable and accurate frequency signal at a frequency different than the received RF carrier frequency. The signal from the voltage controlled oscillator is received into a frequency scaler 159, where the frequency of the signal is scaled to the received carrier frequency. In one example, the frequency scaler implements a scaling factor of 3/2. In this way, the local signal frequency is generated by multiplying the VCO signal by 3, and dividing the resulting signal by 2. Because the signal generated by the VCO is different than the frequency of the carrier, any undesirable mixing effect between the voltage controlled oscillator signal and the carrier signal is substantially reduced. In this way, undesirable DC offset effects are reduced. It will be appreciated that other VCO frequencies and scaling factors may be used.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A local oscillator circuit for a direct conversion radio, comprising:
a voltage controlled oscillator constructed to output a signal at a first frequency;
an input line constructed to receive the signal output by the voltage controlled oscillator;
an output line operating at second frequency and connected to a radio circuit, the second frequency being different than the first frequency; and
a frequency scaling circuit coupled between the input line and the output line, the frequency scaling circuit being constructed to scale the first frequency to the second frequency.

2. The local oscillator circuit according to claim 1, wherein the radio circuit is constructed as a transmitter circuit.

3. The local oscillator circuit according to claim 1, wherein the radio circuit is constructed as a receiver circuit.

4. The local oscillator circuit according to claim 1, wherein the scaling circuit is constructed to apply a scaling factor of 3/2.

5. The local oscillator circuit according to claim 1, wherein the scaling circuit is constructed to selectively apply either a scaling factor of 3/2 or a scaling factor of 3/4.

6. A scaling circuit for a radio circuit, the radio circuit being constructed to operate on a carrier signal, comprising:
an input line arranged to be connected to a frequency source and to receive an input signal at a first frequency;
a frequency scaling circuit connected to the input line, the frequency scaling circuit scaling the frequency of the input signal by a scaling factor to generate an output signal operating at the carrier frequency; and
an output line arranged to be connected to the radio circuit, the output line providing the output signal at the frequency of the carrier signal.

7. A method of providing a signal operating a carrier frequency, comprising:
generating a signal using a voltage controlled oscillator; the signal having a frequency different than the carrier frequency;
scaling the signal by a scaling factor; and
using the scaled signal as the carrier frequency.

8. The method according to claim 7, wherein the scaling factor is set at 3/2.

9. The method according to claim 7, further including the step of selecting a scaling factor from a set of available scaling factors.

10. The method according to claim 7, wherein the carrier frequency is selected for compliance with a wireless communications standard.

11. The method according to claim 10, wherein the wireless communications standard is CDMA, WCDMA, CDMA2000, UMTS, GSM, K-PCS, J-CDMA, or NMT450.

12. A transmitter for a radio system, comprising:
a baseband circuit section for providing a baseband signal;
a transmitter circuit coupled to the baseband circuit section, the transmitter circuit constructed to modulate the baseband signal on to a carrier signal;
a frequency source constructed to generate a frequency signal at a frequency different from the frequency of the carrier signal; and
a scaling circuit connected between the frequency source and the transmitter circuit, the scaling circuit scaling the frequency of the frequency signal to generate the carrier signal.

13. The transmitter according to claim 12, wherein the scaling circuit comprises a multiplication circuit.

14. The transmitter according to claim 13, wherein the scaling circuit comprises a division circuit.

15. A receiver for a radio system, comprising:
a baseband circuit section for receiving a baseband signal;
a receiver circuit coupled to the baseband circuit section, the receiver circuit constructed to demodulate the baseband signal from a carrier signal;
a frequency source constructed to generate a frequency signal at a frequency different from the frequency of the carrier signal; and
a scaling circuit connected between the frequency source and the receiver circuit, the scaling circuit scaling the frequency of the frequency signal to generate the carrier signal.

16. The receiver according to claim 15, wherein the scaling circuit comprises a multiplication circuit.

17. The receiver according to claim 15, wherein the scaling circuit comprises a division circuit.

18. A direct conversion radio, comprising:
a baseband circuit section;
a radio frequency circuit coupled to the baseband section, the radio frequency circuit constructed to operate at a carrier frequency;
a voltage controlled oscillator providing a frequency signal at a frequency different than the carrier frequency; and
a scaling circuit constructed to scale the frequency signal to the carrier frequency.

19. The direct conversion radio according to claim 18, wherein the baseband circuit section, the radio frequency circuit, the voltage controlled oscillator, and the scaling circuit are constructed on a single integrated circuit chip.
